(19) United States
(12) Patent Application Publication
(10) Pub. No.: US 2012/0325360 A1
(43) Pub. Date: Dec. 27, 2012

(54) RIGIDIFIED FLEXIBLE CONDUIT

(75) Inventors: Mark McGrath, Santa Rosa, CA (US); Gregory S. Baeder, Guerneville, CA (US); Scott M. Andrews, Santa Rosa, CA (US)

(73) Assignee: ICORE INTERNATIONAL, INC., Santa Rosa, CA (US)

(21) Appl. No.: 13/492,758

(22) Filed: Jun. 8, 2012

Related U.S. Application Data
(60) Provisional application No. 61/499,479, filed on Jun. 21, 2011.

(51) Int. Cl. F16L 11/00

(52) U.S. Cl. 138/109

(57) ABSTRACT

A rigidified flexible conduit for a conduit run having a predetermined configuration and length, the apparatus including a flexible conduit having a first end and a second end, end fittings disposed at each end, composite bends as required at the ends, at least one rigid medial section disposed in the flexible conduit, and at least one multiple leg transition. The rigid medial section and composite bends, and the multiple leg transitions, if any, are formed from the flexible conduit and an applied coating of a composite matrix material.

### CROSS REFERENCES TO RELATED APPLICATIONS

The present application claims the benefit of the filing date of U.S. Provisional Patent Application Ser. No. 61/499,479, filed Jun. 21, 2011 (Jun. 21, 2011).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

INCORPORATION-BY-REFERENCE OF MATERIAL SUBMITTED ON A COMPACT DISC

Not applicable.

### BACKGROUND OF THE INVENTION

1. Field of the Invention

The present invention relates most generally to electrical, hydraulic, and pneumatic conduits or hoses, cables, and connectors, and more particularly to a conduit assembly consisting of one or more flexible conduits or hoses, with two or more end fittings, and one or more multiple leg transitions, at least one intermediate rigid section, wherein the rigid section is formed around the flexible conduit or hose using a fiber reinforced polymeric composite material, thereby eliminating the need for additional fittings for the flexible/rigid portion junctions.

2. Background Discussion

To achieve maximum flight safety and economy, when providing components for aircraft aerospace manufacturers strive to make components that strike a fine balance between structural integrity and minimal weight while not compromising performance in any way. For instance, it is well known in the art that electrical signal transmission lines for navigation, radar, and in-flight computer controlled systems critical to flight safety must be protected from other nearby lines and more generally from ambient electromagnetic interference (EMI) and radio frequency interference (RFI). Accordingly, aerospace wiring conduits used to house and protect electrical cables and wires for aeronautical applications and avionics traditionally utilized heavy tin-plated copper metal overbraid. Over time, to save on weight, conduits jacketed with wraparound metal foils or metalized fabrics were eventually developed. Further lightweight solutions are constantly being developed.

In addition to wiring conduits, the landing gear and nose wheel steering, brakes, and hydro-mechanical flight controls called for in large aircraft frequently utilize hydraulic lines and piping.

Whether for electrical wiring, hydraulics, or pneumatics, aerospace conduits and hoses must be configured and conformed to fit in tight spaces and must be protected from vibrations or other forces that could degrade or disrupt performance. In some instances conduits can run virtually the entire length of the aircraft. But even short runs of conduits or hoses can include multiple bends. Thus, when employing flexible conduits or hoses, where rigid bends are called for, the rigid sections are typically provided by terminating a flexible portion with a fitting, coupling it to a first end of a rigid (typically metal) portion having a complementary fitting, and then coupling a fitting on the second end of the rigid portion to another section of flexible conduit having a complementary fitting, and so on for as many rigid bends as are required under the circumstances.

By way of example, if a complete conduit assembly requires three flexible sections and two rigid sections, there are a total of four junctions between the sections that require a total of ten fittings. Those fittings are generally welded onto the rigid sections and swaged onto the flexible sections. The fabrication costs can be quite high, as the fittings themselves must be provided, attached to the conduit sections, and then assembled, making the weight increase substantial. Furthermore, each juncture presents an increased risk of failure and leaks at the assembled joints.

### SUMMARY OF THE INVENTION

The present invention provides a novel method for creating a continuous system of flexible conduits or hoses having one or more rigidified sections. Composite bends, end fittings, the medial sections and multiple leg transitions, as required, are incorporated into a unified whole by using a composite matrix material to coat the conduit at the ends, the medial section, or anywhere the rigidifying is required. Brackets can also be incorporated into the rigidified portions of the conduit or hose run. This assembly entirely obviates the need for multiple fittings. This results in reduced manufacturing costs, reduces overall apparatus weight, and substantially reduces the risk of conduit and fitting failure.

### BRIEF DESCRIPTION OF THE SEVERAL VIEWS OF THE DRAWINGS

FIG. 1 is a schematic top plan view of an embodiment of the rigidified flexible conduit of the present invention.

### DETAILED DESCRIPTION OF THE INVENTION

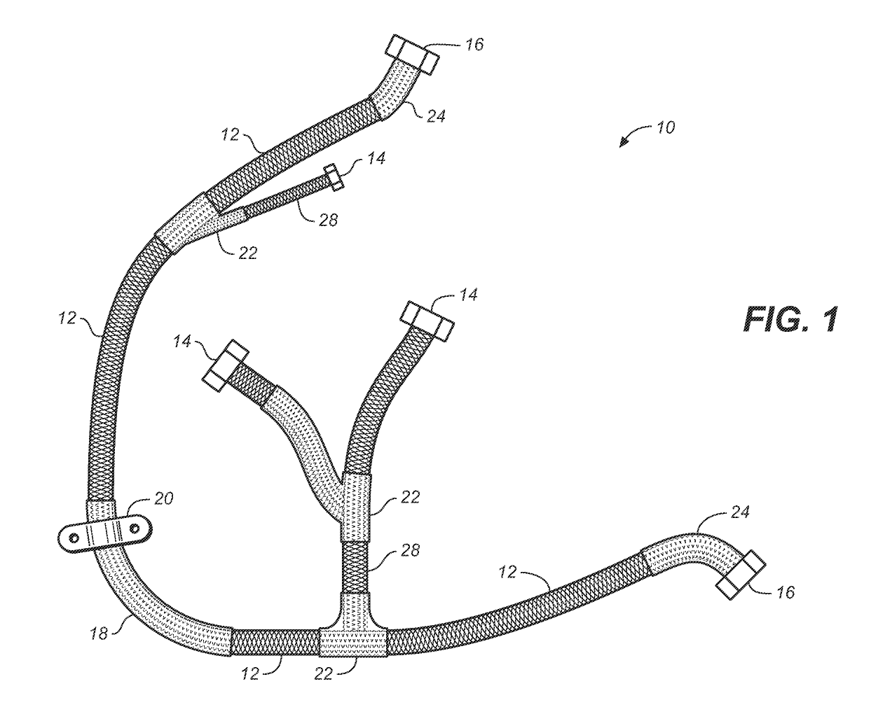

Referring to FIG. 1, the present invention 10, provides a novel means to rigidify a run of conduit or hose in virtually any configuration without the expense and complexity of having to provide multiple fittings and junctions. For any given run of conduit or hose, the invention includes a length of flexible conduit or hose 12 having two or more end fittings 14, 16. In the illustration, the conduit or hose is agnostic (of indeterminate type) and could be an electrical wiring conduit, hydraulic line, or pneumatic tubing. If employed as an electrical wiring conduit, the structural elements may include a corrugated or convoluted tubular body, typically made from ethylene tetrafluoroethylene (ETFE), polytetrafluoroethylene (PTFE), or polyether ether ketone (PEEK), with or without one or two layers of braided metal wire shielding made from stainless steel or copper plated with tin or nickel. Overbraiding may be provided by a durable fabric, such as Dacron® (Dacron is a registered trademark of E. I. Du Pont De Nemours and Company Corporation of Wilmington, Del.), or other fabric, aviation grade approved. The fittings shown are also agnostic and schematically show that the fittings can be either electrical wiring conduit fittings, hydraulic fittings, or pneumatic tube end fittings.

The medial rigid section 18, the rigid end sections 24 and any multiple leg transitions 22, are formed by the application of a composite matrix material, preferably a polymer matrix material reinforced with various materials, such as s-glass fibers, carbon fiber, aramid, and the like, perhaps even including paper, wood, or asbestos, summarily identified as a fiber-reinforced polymer. (In the embodiment shown, only one rigid medial section 18 and transitions with three branches 22 are illustrated, but the number of rigid sections or transition branches is essentially indefinite, depending on the length and configuration of the conduit or hose run.) Brackets 20 for attaching the conduit to airframe structures may be incorporated or integrated into the composite material section or placed over the rigid section at the time of installation.

Composite bends 24 can also be (though need not be) provided at the conduit ends immediately proximate the end fittings. Multiple leg transitions 22 can connect lateral branches 28 of flexible conduit or hose with the main flexible conduit or hose 12. In this manner a system of flexible conduits or hoses having rigidified sections can be provided. Such an assembly eliminates entirely the need for multiple fittings, thereby reducing manufacturing costs, overall apparatus weight, and risk of apparatus failure.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

1. A rigidified flexible conduit for a conduit run having a predetermined configuration and length, comprising:
a primary flexible conduit having a first end and a second end;
end fittings disposed at each of said first and second ends; and
at least one rigid medial section disposed in said primary flexible conduit, said at least one rigid medial section formed from said flexible conduit and a coating of a composite matrix material.

2. The apparatus of claim 1, wherein said composite matrix material is a polymer matrix material reinforced with fibers selected from the group consisting of s-glass fibers, carbon fiber, aramid.

3. The apparatus of claim 1, wherein said conduit is selected from the group consisting of electrical wiring conduit, hydraulic line, and pneumatic tubing.

4. The apparatus of claim 1, wherein said conduit is a corrugated or convoluted electrical wiring conduit and is fabricated from material selected from the group consisting of ethylene tetrafluoroethylene, polytetrafluoroethylene, and polyether ether ketone.

5. The apparatus of claim 4, further including at least one layer of braided metal wire shielding made from stainless steel or copper plated with tin or nickel

6. The apparatus of claim 4, further including overbraiding fabricated from a durable synthetic fibers.

7. The apparatus of claim 6, wherein said durable synthetic fibers comprise polyethylene terephthalate.

8. The apparatus of claim 1, wherein said fittings are selected from the group consisting of electrical wiring conduit fittings, hydraulic fittings, and pneumatic tube end fittings.

9. The apparatus of claim 1, further including at least one bracket for attaching said conduit to a substrate, said bracket integrated into said at least one rigid medial section using said composite matrix material.

10. The apparatus of claim 1, wherein at least one of said first and said second end includes a composite bend immediately proximate its respective end fitting.

11. The apparatus of claim 1, further including at least one multiple leg transition connecting lateral branch conduits to said primary flexible conduit.
